(19) United States
(12) Patent Application Publication
(10) Pub. No.: US 2004/0122782 A1
(43) Pub. Date: Jun. 24, 2004

(54) Process for determining the composition of a dye product

(75) Inventors: Marie-Pascale Audousset, Asnieres (FR); Jean-Marie Millequant, Saint Maur des Fosses (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 10/617,304

(22) Filed: Jul. 11, 2003

Related U.S. Application Data
(60) Provisional application No. 60/398,566, filed on Jul. 26, 2002.

(30) Foreign Application Priority Data
Jul. 11, 2002 (FR) 02 08762

(51) Int. Cl. G06F 17/00

(52) U.S. Cl. 705/500

(57) ABSTRACT

A process, system, database, and computer program product are configured to determine the composition of a product for dyeing keratin fibers. Data representing a target coloration is entered and/or received. Using the database, a dye product is determined based on the target coloration. The composition of the dye product is displayed and/or transmitted so as to identify at least one dye component to produce the dye product, and to identify the proportion for the dye component. The dye product can be determined so as to obtain the target coloration, or to obtain a coloration that differs from the target coloration by not more than a predetermined value.

### CROSS REFERENCE TO RELATED APPLICATIONS

This document claims priority to French application number 0208762 filed Jul. 11, 2002, the entire content of which is hereby incorporated by reference. This document also claims priority to U.S. Provisional Application serial No. 60/398,566 filed Jul. 26, 2002, the entire content of which is hereby incorporated by reference.

### BACKGROUND OF THE INVENTION

1. Field of the Invention

The invention relates to a process for determining the composition of a product for dyeing keratin fibers.

2. Description of the Background

Hair dyeing is currently used in cosmetics to allow a person to hide grey or white hair, and/or to modify the color of his/her hair. Several types of hair dyeing operation exist. Temporary or “transient” dyeing fades out with a slight amount of shampoo washing. Semi-permanent or direct dyeing fades out relatively slowly after several shampoo washes. Permanent dyeing allows a modification of the pigmentation of the hair.

Dye products make it possible to obtain three types of result: to add various glints to the natural color of the hair; to color white/grey hair in natural tones so as to restore the original shade, or a lighter or darker shade, to the whole head of hair; and to “deyellow” grey or white hairs by giving them a grey tonality, the type of product used being referred to as giving “grey glints.”

Hereafter, the expression “dye component” means an item including one or more constituents, which is capable by itself of dyeing. Such an item can include:

i) a single base;

ii) a base and a coupler; or

iii) a direct dye.

Thus, the direct dyeing products include, as a dye component, one or more dyes, depending on the desired result. Oxidation dye products include, as a dye component, at least one base and generally at least one coupler, and optionally one or more direct dyes.

The dye components are introduced into a support, which is, for example, a cream or a gel, and which facilitates the application of the dye product to the hair. Each base mixed with a coupler gives rise to a pigment that binds to the hair, by oxidation in the presence of an oxidizing agent, for instance hydrogen peroxide, and by polymerization. The existing number of bases and couplers is limited in practice. However, the various possible mixtures of these bases and couplers considerably increase the total number of dye compositions. The diversity of natural hair colors, ranging from black to very light blonde, and the diversity of consumer tastes as regards the desired colors and glints, complicates the task of a hair stylist in the choice of the appropriate dye product. It then becomes difficult, even for an experienced hair stylist, to produce, even by mixing, the dye product that will result in the exact desired coloration.

Manufacturers propose prefabricated dye products. Examples of colorations obtained with particular products are displayed on the product packaging or on a color chart. However, due to the diversity of hair types, especially of their colors, which range from blonde to brown and which comprise a certain percentage of white/grey hairs, the same dye product does not lead to the same result, and the final coloration obtained is not always that expected.

The document U.S. Pat. No. 6,330,341 discloses compiling a database providing, for each commercially existing dye product, the final coloration obtained as a function of the initial color of the hair. This database collates a large number of commercially existing products.

This document also describes a process for determining the commercial dye product(s) for obtaining a desired coloration. Such a process requires the user to have available all the products registered in the database, which is not feasible for a hair salon, since this would demand an excessively large stock of products. Furthermore, this process is limited to commercially existing products.

The number of dye components forming part of the composition of dye products, whether for direct dyeing or for oxidation dyeing, is smaller than the number of dye products that may be sold. It is therefore preferable, for a small business such as a hair salon, to have available dye components in individualized form, and to produce the dye product as and when needed by its clients by mixing together the components required to obtain the desired coloration. However, as stated above, it is not easy for a hair stylist to formulate the exact dye product for obtaining the desired coloration.

### SUMMARY OF THE INVENTION

The invention proposes a process for producing the required dye product from base dye components. The invention more particularly covers a process for determining the composition of a product for dyeing keratin fibers. The process can include a step of entering and/or receiving at least one item of data representative of a target coloration to be achieved. The process can also include a step of determining, from a database, at least one product for obtaining the target coloration or a theoretical coloration that differs from the target coloration by not more than a predetermined theoretical value. The process can also include a step of determining a predetermined number of products for obtaining the theoretical colorations that are closest to the target coloration. The invention can also include a step of transmitting and/or displaying the composition of each determined product, mentioning the dye components required to produce the product, and also the proportions of each required component.

Other features of the invention can include transmitting and/or displaying, for each determined product, at least one value representative of the difference between the theoretical coloration obtained with the product and the target coloration. The display step can also include displaying, for each determined product, a colored graph component whose coloration is the theoretical coloration obtained with the product. The display step can also include displaying the determined products by arranging them in order of proximity between the theoretical coloration and the target coloration.

The determination step can include selecting one or more products present in the database and/or in determining the composition of one or more products by numerical calculation. The dye component can include an oxidation base and optionally an oxidation coupler. The dye component can include a direct dye. The process can include a step of entering at least one characteristic of the hair to be dyed, preferably before the step of entering the target color. The characteristic can be an item of data representative of the real color of the hair to be dyed. The process can include a step of identifying a subset, e.g., a small set, of dye components chosen from all the dye components contained in the database, the determination step including determining dye products formed from one or more dye components of this small set.

The invention also covers a process for preparing a dye product, which includes i) determining, using one of the above processes, the proportion of one or more dye components forming part of the dye product to be prepared; and ii) preparing the dye product by incorporating therein the dye component(s) determined during step i), in the proportions determined during step i).

The invention also covers a database that can be used for carrying out one of the processes described above. The database includes:

a) a first set of data for identifying a plurality of dye components,

b) a second set of data including:

i) the concentration of the dye component(s), chosen from the plurality of dye components, and entering into the preparation of a plurality of dye products; and

ii) for each of the dye products, the color obtained when they are applied under predefined conditions.

The predefined conditions can be conditions relating to the percentage of mixing with an oxidizing agent of variable strength, the type of fibers onto which the product has been applied, the content of white or grey hairs and/or sensitized hairs, the temperature, and the action time. These predefined conditions may or may not form part of the displayed information. According to a particular embodiment of the invention, the database includes third set of data representative of economic and/or regulatory characteristics of at least one of the dye products.

The invention also covers a process for compiling a database described above. The process can include:

i) a step of recording the first set of data, and

ii) a step of recording the second associated set of data.

According to a particular embodiment of the invention, the process for compiling the database includes a step of updating the database by recording the second set of data relating to at least one new dye product. The updating step can include the recording of at least one new data for the first set.

The invention also covers a system for determining the composition of a product for dyeing keratin fibers. The system is configured to carry out the processes described above. The system includes:

i) means for entering at least one item of data representative of a target coloration;

ii) calculation means for determining, from a database, at least one product for obtaining the target coloration or a theoretical coloration that differs from the target coloration by not more than a predetermined theoretical value, or a predetermined number of products for obtaining theoretical colorations that are closest to the target coloration, and

iii) means for displaying the composition of each determined product, identifying the dye components required to produce them, and also the respective proportions thereof.

According to a particular embodiment of the invention, the database, and optionally the calculation means, are remotely located relative to the entering means and the display means. The data between at least some of the constituents of the system can be transmitted over a network, such as for example the Internet. The means for entering the target coloration can include an electronic calorimeter and/or an electronic spectrocolorimeter.

### BRIEF DESCRIPTION OF THE DRAWINGS

A better appreciation of the invention and many of the attendant advantages thereof will become further apparent from the following detailed description, particularly when read in conjunction with the accompanying drawings of which:

FIG. 1 is a schematic representation of a system in accordance with the invention;

FIG. 2 is a schematic representation of a database in accordance with the invention, wherein by way of example the first, second, third and fourth set of data are distributed in columns, and in which each row determines the formulation of a dye product;

FIG. 3 is a graph representing the value of the coefficient K/S as a function of the concentration of the dye product, for a given dye product and for a given wavelength value;

FIG. 4 is a graph representing the value of the coefficient K/S as a function of the wavelength, for the same dye product, and in which each curve corresponds to a given concentration of the dye product.

### DETAILED DESCRIPTION OF THE PREFERRED EMBODIMENTS

According to the present invention, a dye product can include one or more oxidation bases chosen from para-phenylenediamines, bis(phenyl)alkylenediamines, para-aminophenols, ortho-aminophenols and heterocyclic bases, and the addition salts thereof. The para-phenylenediamines include, for example, para-phenylenediamine, para-tolylenediamine, 2-chloro-para-phenylenediamine, 2,3-dimethyl-para-phenylenediamine, 2,6-dimethyl-para-phenylenediamine, 2,6 diethyl-para-phenylenediamine, 2,5-dimethyl-para-phenylenediamine, N,N-dimethyl-para-phenylenediamine, N,N-diethyl-para-phenylenediamine, N,N-dipropyl-para-phenylenediamine, 4-amino-N,N-diethyl-3-methylaniline, N,N-bis(β-hydroxyethyl)-para-phenylenediamine, 4-N,N-bis(β-hydroxyethyl)amino-2 methylaniline, 4-N,N-bis(β-hydroxyethyl)amino-2 chloroaniline, 2-β-hydroxyethyl-para-phenylenediamine, 2-fluoro-para-phenylenediamine, 2 isopropyl-para-phenylenediamine, N-(β hydroxypropyl)-para-phenylenediamine, 2-hydroxymethyl-para-phenylenediamine, N,N-dimethyl-3-methyl-para-phenytenediamine, N-ethyl-N-(β-hydroxyethyl)-para-phenylenediamine, N (β,γ-dihydroxypropyl)-para-phenylenediamine, N-(4′-aminophenyl)-para-phenylenediamine, N-phenyl-para-phenylenediamine, 2-β-hydroxyethyloxy-para-phenylenediamine, 2-β-acetylaminoethyloxy-para-phenylenediamine, N (β methoxyethyl) para-phenylenediamine, 4 aminophenylpyrrolidine, 2-thienyl-para-phenylenediamine, 2 β-hydroxyethylamino-5 aminotoluene and 3 hydroxy-1 (4′-aminophenyl)pyrrolidine, and the addition salts thereof with an acid.

Among the para-phenylenediamines mentioned above, para-phenylenediamine, para-tolylenediamine, 2-isopropyl-para-phenylenediamine, 2-β-hydroxyethyl-para-phenylenediamine, 2-β-hydroxyethyloxy-para-phenylenediamine, 2,6-dimethyl-para-phenylenediamine, 2,6-diethyl-para-phenylenediamine, 2,3-dimethyl-para-phenylenediamine, N,N-bis(β-hydroxyethyl)-para-phenylenediamine, 2 chloro-para-phenylenediamine and 2 β acetylaminoethyloxy-para-phenylenediamine, and the addition salts thereof with an acid, are preferred.

The bis(phenyl)alkylenediamines include, for example, N,N′ bis(β-hydroxyethyl)-N,N′-bis(4′-aminophenyl)-1,3-diaminopropanol, N,N′ bis(β-hydroxyethyl)-N,N′-bis(4′-aminophenyl)ethylenediamine, N,N′ bis(4-aminophenyl)tetramethylenediamine, N,N′ bis(β-hydroxyethyl)-N,N′-bis(4-aminophenyl)tetramethylenediamine, N,N′ bis(4-methylaminophenyl)tetramethylenediamine, N,N′ bis(ethyl)-N,N′-bis(4′-amino-3′-methylphenyl)ethylenediamine and 1,8 bis(2,5-diaminophenoxy)-3,6-dioxaoctane, and the addition salts thereof with an acid.

The para-aminophenols can include, for example, para-aminophenol, 4 amino-3-methylphenol, 4 amino-3-fluorophenol, 4 amino-3 hydroxymethylphenol, 4 amino-2-methylphenol, 4 amino-2 hydroxymethylphenol, 4 amino-2-methoxymethylphenol, 4 amino-2-aminomethylphenol, 4 amino-2 (β-hydroxyethylaminomethyl)phenol and 4 amino-2 fluorophenol, and the addition salts thereof with an acid.

The ortho-aminophenols can include, for example, 2 aminophenol, 2 amino-5-methylphenol, 2 amino-6 methylphenol and 5-acetamido-2-aminophenol, and the addition salts thereof with an acid.

The heterocyclic bases can include, for example, pyridine derivatives, pyrimidine derivatives and pyrazole derivatives.

The pyridine derivatives can include, for example, the compounds described in patents GB 1 026 978 and GB 1 153 196, such as 2,5 diaminopyridine, 2-(4-methoxyphenyl)amino-3 aminopyridine, 2,3-diamino-6-methoxypyridine, 2 (β-methoxyethyl)amino-3-amino-6-methoxypyridine and 3,4-diaminopyridine, and the addition salts thereof with an acid. Other pyridine oxidation bases are the 3 aminopyrazolo[1,5 a]pyridine oxidation bases or the addition salts thereof described, for example, in patent application FR 2 801 308. These include, for example, pyrazolo[1,5 a]pyrid-3-ylamine; 2 acetylaminopyrazolo[1,5 a]pyrid-3-ylamine; 2 morpholin-4-ylpyrazolo[1,5 a]pyrid-3-ylamine; 3 aminopyrazolo[1,5 a]pyridine-2-carboxylic acid; 2 methoxypyrazolo[1,5 a]pyrid-3-ylamine; (3 aminopyrazolo[1,5 a]pyrid-7 yl)methanol; 2-(3-aminopyrazolo[1,5 a]pyrid-5-yl)ethanol; 2 (3 aminopyrazolo[1,5 a]pyrid-7-yl)ethanol; (3 aminopyrazolo[1,5 a]pyrid-2-yl)methanol; 3,6 diaminopyrazolo[1,5 a]pyridine; 3,4 diaminopyrazolo[1,5 a]pyridine; pyrazolo[1,5 a]pyridine-3,7 diamine; 7-morpholin-4 ylpyrazolo[1,5-a]pyrid-3-ylamine; pyrazolo[1,5 a]pyridine-3,5-diamine; 5 morpholin-4 ylpyrazolo[1,5 a]pyrid-3-ylamine; 2 [(3 aminopyrazolo[1,5 a]pyrid-5-yl)(2-hydroxyethyl)amino]ethanol; 2-[(3-aminopyrazolo[1,5 a]pyrid-7 yl)(2 hydroxyethyl)amino]ethanol; 3 aminopyrazolo[1,5 a]pyrid-5-ol; 3 aminopyrazolo[1,5 a]pyrid-4-ol; 3 aminopyrazolo[1,5 a]pyrid-6-ol; 3 aminopyrazolo[1,5 a]pyrid-7-ol; and also the addition salts thereof with an acid or with a base.

The pyrimidine derivatives can include the compounds described, for example, in patents DE 2 359 399; JP 88 169 571; JP 05-63124; EP 0 770 375 or patent application WO 96/15765, such as 2,4,5,6-tetraaminopyrimidine, 4 hydroxy-2,5,6-triaminopyrimidine, 2 hydroxy-4,5,6-triaminopyrimidine, 2,4-dihydroxy-5,6-diaminopyrimidine and 2,5,6-triaminopyrimidine, and pyrazolopyrimidine derivatives such as those mentioned in patent application FR A 2 750 048, for example pyrazolo[1,5-a]pyrimidine-3,7-diamine; 2,5-dimethylpyrazolo[1,5-a]pyrimidine-3,7-diamine; pyrazolo[1,5-a]pyrimidine-3,5-diamine; 2,7 dimethylpyrazolo[1.5 a]pyrimidine-3,5-diamine; 3 aminopyrazolo[1,5-a]pyrimidin-7 ol; 3-aminopyrazolo[1,5 -a]pyrimidin-5 -ol; 2-(3-aminopyrazolo[1,5 -a]pyrimidin-7-ylamino)ethanol, 2-(7-aminopyrazolo[1,5-a]pyrimidin-3-ylamino)ethanol, 2-[(3-aminopyrazolo[1,5-a]pyrimidin-7-yl)(2-hydroxyethyl)amino]ethanol, 2 [(7 aminopyrazolo[1,5 a]pyrimidin-3-yl)(2-hydroxyethyl)amino]ethanol, 5,6 dimethylpyrazolo[1,5-a]pyrimidine-3,7-diamine, 2,6-dimethylpyrazolo[1,5 a]pyrimidine-3,7-diamine, 2,5,N7,N7-tetramethylpyrazolo[1,5-a]pyrimidine-3,7-diamine and 3 amino-5 methyl-7 imidazolylpropylaminopyrazolo[1,5 a]pyrimidine, and the addition salts thereof with an acid and the tautomeric forms thereof, when a tautomeric equilibrium exists.

The pyrazole derivatives can include, for example, the compounds described in patents DE 3 843 892 and DE 4 133 957 and patent applications WO 94/08969, WO 94/08970, FR A-2 733 749 and DE 195 43 988, such as 4,5 diamino-1-methylpyrazole, 4,5 diamino-1-(β-hydroxyethyl)pyrazole, 3,4 diaminopyrazole, 4,5-diamino-1-(4′-chlorobenzyl)pyrazole, 4,5 diamino-1,3-dimethylpyrazole, 4,5 diamino-3 methyl-1-phenylpyrazole, 4,5-diamino-1 methyl-3-phenylpyrazole, 4-amino-1,3-dimethyl-5 hydrazinopyrazole, 1 benzyl-4,5-diamino-3 methylpyrazole, 4,5-diamino-3-tert-butyl-1 methylpyrazole, 4,5-diamino-1-tert-butyl-3 methylpyrazole, 4,5 diamino-1-(β-hydroxyethyl)-3 methylpyrazole, 4,5-diamino-1 ethyl-3 methylpyrazole, 4,5-diamino-1-ethyl-3-(4′methoxyphenyl)pyrazole, 4,5 diamino-1-ethyl-3-hydroxymethylpyrazole, 4,5 diamino-3-hydroxymethyl-1-methylpyrazole, 4,5 diamino-3 hydroxymethyl- 1 -isopropylpyrazole, 4,5 diamino-3-methyl-1 isopropylpyrazole, 4-amino-5 (2′-aminoethyl)amino-1,3 dimethylpyrazole, 3,4,5 triaminopyrazole, 1-methyl-3,4,5 triaminopyrazole, 3,5-diamino-1-methyl-4 methylaminopyrazole and 3,5-diamino-4-(β-hydroxyethyl)amino-1-methylpyrazole, and the addition salts thereof with an acid.

The oxidation base(s) present in the dye product is(are) each generally present in an amount of between 0.001% and 10% and preferably between 0.005% and 6% by weight approximately relative to the total weight of the dye composition.

The dye product can also include, for example, one or more couplers conventionally used for dyeing keratin fibers. These couplers can include, for example, meta-phenylenediamines, meta-aminophenols, meta-diphenols, naphthalene-based couplers and heterocyclic couplers, and the addition salts thereof. Other examples include 2 methyl-5 aminophenol, 5 N-(β-hydroxyethyl)amino-2 methylphenol, 6 chloro-2 methyl-5 aminophenol, 3 aminophenol, 1,3 dihydroxybenzene, 1,3 dihydroxy-2 methylbenzene, 4 chloro-1,3 dihydroxybenzene, 2,4 diamino-1-(β-hydroxyethyloxy)benzene, 2 amino-4 (β-hydroxyethylamino)-1-methoxybenzene, 1,3 diaminobenzene, 1,3-bis(2,4-diaminophenoxy)propane, 3 ureidoaniline, 3-ureido-1-dimethylaminobenzene, sesamol, 1β-hydroxyethylamino-3,4 methylenedioxybenzene, α-naphthol, 2-methyl-1-naphthol, 6 hydroxyindole, 4 hydroxyindole, 4 hydroxy-N-methylindole, 2 amino-3 hydroxypyridine, 6 hydroxybenzomorpholine, 3,5-diamino-2,6-dimethoxypyridine, 1 N (β-hydroxyethyl)amino-3,4-methylenedioxybenzene and 2,6 bis(β-hydroxyethylamino)toluene and the addition salts thereof with an acid.

In the dye product, the coupler(s) is(are) each generally present in an amount of between 0.001% and 10% and preferably between 0.005% and 6% by weight approximately relative to the total weight of the dye composition.

In general, the addition salts of the oxidation bases and of the couplers that can be used in the context of the invention are chosen from the addition salts with an acid, such as the hydrochlorides, hydrobromides, sulphates, citrates, succinates, tartrates, lactates, tosylates, benzenesulphonates, phosphates and acetates, and the addition salts with a base, such as sodium hydroxide, potassium hydroxide, ammonia, amines or alkanolamines.

The direct dyes that can form part of the composition of the dye product are preferably chosen from neutral, acidic or cationic nitrobenzene direct dyes, neutral, acidic or cationic azo direct dyes, neutral, acidic or cationic quinone and in particular anthraquinone direct dyes, azine direct dyes, triarylmethane direct dyes, indoamine direct dyes and natural direct dyes.

Among the benzenic direct dyes, which can form part of the composition of the dye product, the following exemplary non-limiting compounds can be used:

1,4-diamino-2-nitrobenzene

1-amino-2-nitro-4-(β-hydroxyethylamino)benzene

1-amino-2-nitro-4-bis(β-hydroxyethyl)aminobenzene

1,4-bis(β-hydroxyethylamino)-2-nitrobenzene

1-β-hydroxyethylamino-2-nitro-4-bis-(β-hydroxyethylamino)benzene

1-β-hydroxyethylamino-2-nitro-4-aminobenzene

1-β-hydroxyethylamino-2-nitro-4-(ethyl)(β-hydroxyethyl)aminobenzene

1-amino-3-methyl-4-β-hydroxyethylamino-6-nitrobenzene

1-amino-2-nitro-4-β-hydroxyethylamino-5-chlorobenzene

1,2-diamino-4-nitrobenzene

1-amino-2-β-hydroxyethylamino-5-nitrobenzene

1,2-bis(β-hydroxyethylamino)-4-nitrobenzene

1-amino-2-[tris(hydroxymethyl)methylamnino]-5-nitrobenzene

1-hydroxy-2-amino-5-nitrobenzene

1-hydroxy-2-amino-4-nitrobenzene

1-hydroxy-3-nitro-4-aminobenzene

1-hydroxy-2-amino-4,6-dinitrobenzene

1-β-hydroxyethyloxy-2-β-hydroxyethylamino-5-nitrobenzene

1-methoxy-2-β-hydroxyethylamino-5-nitrobenzene

1-β-hydroxyethyloxy-3-methylamino-4-nitrobenzene

1-β,γ-dihydroxypropyloxy-3-methylamino-4-nitrobenzene

1-β-hydroxyethylamino-4-β,γ-dihydroxypropyloxy-2 nitrobenzene

1-β,γ-dihydroxypropylamino-4-trifluoromethyl-2 nitrobenzene

1-β-hydroxyethylamino-4-trifluoromethyl-2-nitrobenzene

1-β-hydroxyethylamino-3-methyl-2-nitrobenzene

1-β-aminoethylamino-5-methoxy-2-nitrobenzene

1-hydroxy-2-chloro-6-ethylamino-4-nitrobenzene

1-hydroxy-2-chloro-6-amino-4-nitrobenzene

1-hydroxy-6-[bis(β-hydroxyethyl)amino]-3-nitrobenzene

1-β-hydroxyethylamino-2-nitrobenzene

1-hydroxy-4-β-hydroxyethylamino-3-nitrobenzene.

The azo direct dyes, which can form part of the composition of the dye product, include for example the cationic azo dyes described in patent applications WO 95/15144, WO 95/01772 and EP 714 954. These compounds include the following dyes:

1,3 dimethyl 2 [[4(dimethylamino)phenyl]azo] 1H-imidazolium chloride,

1,3-dimethyl-2-[(4-aminophenyl)azo]-1H-imidazolium chloride,

1-methyl-4[(methylphenylhydrazono)methyl]pyridinium methyl sulphate.

The azo direct dyes, which can also be used in the present invention, include the following dyes described in the Color Index International 3rd edition:

Disperse Red 17

Acid Yellow 9

Acid Black 1

Basic Red 22

Basic Red 76

Basic Yellow 57

Basic Brown 16

Acid Yellow 36

Acid Orange 7

Acid Red 33

Acid Red 35

Basic Brown 17

Acid Yellow 23

Acid Orange 24

Disperse Black 9.

The following can also be used: 1 (4′ aminodiphenylazo)-2 methyl-4-[bis(β-hydroxyethyl)amino]benzene and 4-hydroxy-3 (2-methoxyphenylazo)-1 -naphthalenesulfonic acid.

The quinone direct dyes that can be used include, for example, the following dyes:

Disperse Red 15

Solvent Violet 13

Acid Violet 43

Disperse Violet 1

Disperse Violet 4

Disperse Blue 1

Disperse Violet 8

Disperse Blue 3

Disperse Red 11

Acid Blue 62

Disperse Blue 7

Basic Blue 22

Disperse Violet 15

Basic Blue 99

The following compounds can also be used:

1-N-methylmorpholiniumpropylamino-4-hydroxyanthraquinone

1-aminopropylamino-4-methylaminoanthraquinone

1-aminopropylaminoanthraquinone

5-β-hydroxyethyl-1,4-diaminoanthraquinone

2-aminoethylamino anthraquinone

1,4-bis(β,γ-dihydroxypropylamino)anthraquinone

Among the azine dyes that can be used are the following compounds:

Basic Blue 17

Basic Red 2.

The triarylmethane dyes, which can form part of the composition of the dye product, include for example the following compounds:

Basic Green 1

Acid Blue 9

Basic Violet 3

Basic Violet 14

Basic Blue 7

Acid Violet 49

Basic Blue 26

Acid Blue 7

The indoamine dyes, which can form part of the composition of the dye product, include for example the following compounds:

2-β-hydroxyethylamino-5-[bis(β-4′-hydroxyethyl)amino]anilino-1,4-benzoquinone;

2-β-hydroxyethylamino-5-(2′-methoxy-4′-amino)anilino-1,4 benzoquinone;

3-N(2′-chloro-4′-hydroxy)phenylacetylamino-6-methoxy- 1,4-benzoquinoneimine;

3-N(3′-chloro-4′-methylamino)phenylureido-6-methyl- 1,4-benzoquinoneimine;

3-[4′-N-(ethylcarbamylmethyl)amino]phenylureido-6-methyl- 1,4-benzoquinoneimine.

The natural direct dyes, which can form part of the composition of the dye product, include for example lawsone, juglone, alizarin, purpurin, carminic acid, kermesic acid, purpurogallin, proto catechaldehyde, indigo, isatin, curcumin, spinulosin and apigenidin. Extracts or decoctions containing these natural dyes can also be used, and especially henna-based poultices or extracts.

The direct dye(s) preferably represent(s) from 0.001% to 20% by weight approximately, and even more preferably from 0.005% to 10% by weight approximately, relative to the total weight of the ready-to-use dye product.

The medium which is suitable for dyeing, also known as the dye support, generally includes water or a mixture of water and at least one organic solvent to dissolve the compounds which would not be sufficiently soluble in water. The organic solvent can include for example C₁-C₄ lower alkanols, such as ethanol and isopropanol; polyols and polyol ethers such as 2 butoxyethanol, propylene glycol, propylene glycol monomethyl ether, diethylene glycol monoethyl ether and monomethyl ether, as well as aromatic alcohols such as benzyl alcohol or phenoxyethanol, and mixtures thereof.

The solvents are preferably present in proportions preferably between 1% and 40% by weight approximately relative to the total weight of the dye composition, and even more preferably between 5% and 30% by weight approximately.

The dye product can also include various adjuvants conventionally used in compositions for dyeing the hair, such as anionic, cationic, nonionic, amphoteric or zwitterionic surfactants or mixtures thereof, anionic, cationic, nonionic, amphoteric or zwitterionic polymers or mixtures thereof, inorganic or organic thickeners, and in particular anionic, cationic, nonionic or amphoteric associative polymeric thickeners, antioxidants, penetration agents, sequestering agents, fragrances, buffers, dispersing agents, packaging agents such as, for example, silicones, which may or may not be volatile or modified, film-forming agents, ceramides, preserving agents and opacifiers. The above adjuvants are generally present in an amount for each of them of between 0.01% and 20% by weight relative to the weight of the dye product.

The pH of the dye product is generally between about 3 and 12 and preferably between about 5 and 11. It can be adjusted to the desired value using acidifying or basifying agents usually used in the dyeing of keratin fibers, or alternatively using standard buffer systems.

The acidifying agents include, for example, inorganic or organic acids such as hydrochloric acid, orthophosphoric acid, sulphuric acid, carboxylic acids such as acetic acid, tartaric acid, citric acid and lactic acid, and sulphonic acids.

The basifying agents include, for example, aqueous ammonia, alkaline carbonates, alkanolamines such as mono , di and triethanolamine and derivatives thereof, sodium hydroxide, potassium hydroxide and the compounds having the following formula:

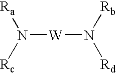

in which W is a propylene residue which is unsubstituted or substituted with a hydroxyl group or a C₁-C₄ alkyl radical; Rₐ, R_{b}, R_{c} and R_{d}, which may be identical or different, represent a hydrogen atom, a C₁-C₄ alkyl radical or a C₁-C₄ hydroxyalkyl radical.

The dye product can be in various forms, such as in the form of liquids, creams or gels, or in any other form that is suitable for dyeing keratin fibers, and especially human hair.

Modern instruments measure the amount of light that is reflected by a colored sample at different wavelengths, to establish the spectral characteristics of the illuminated article.

Apart from black, which reflects no light, and white, which reflects all the light, all colors reflect light only in certain specific regions of the visible spectrum. In these cases, they have characteristic spectral curves that form “identity cards” of the colors, two colors being identical only if their spectra are superimposable.

To make an objective and systematic description of colors, and in contrast with visual perception which is subjective since it depends especially on the observer and the observation conditions, a standardized colorimetric system can be used. For the representation of a point of color in space and for the calculation of color differences, the CIELAB colorimetric system established by the International Commission on Illumination (CIE) is the one that is currently the most widely used.

This system uses three values, L*, a* and b*, in which the value L* expresses the lightness, and the values a* and b* express the hue and the saturation of a color. Thus, L* ranges from black to white, a* ranges from green to red passing through grey, and b* expresses the variation from blue to yellow also passing through grey. The difference between two colors may be expressed by the relationship:

ΔE*=\sqrt{(ΔL*)²+(Δa*)²+(Δb*)²}

Each dye component has a calibration curve that is the spectral curve of the coloration that can be obtained thereby on a given type of hair and as a function of its concentration.

Referring to FIG. 2, the invention covers a database 10 for determining, for a given dye component or for a given mixture of dye components, the coloration obtained. The database 10 may be compiled, for example, by recording values of L* , a* and b* for each composition.

The database 10 may also be compiled from the coefficients K/S determined at one or more wavelengths.

The coefficient K/S is determined from the reflectance R of the color under consideration, by the relationship

$$K / S = \frac{( 1 - {R}^{2} )}{2 R} ,$$

the reflectance R being the ratio between the light energy retransmitted and the incident energy.

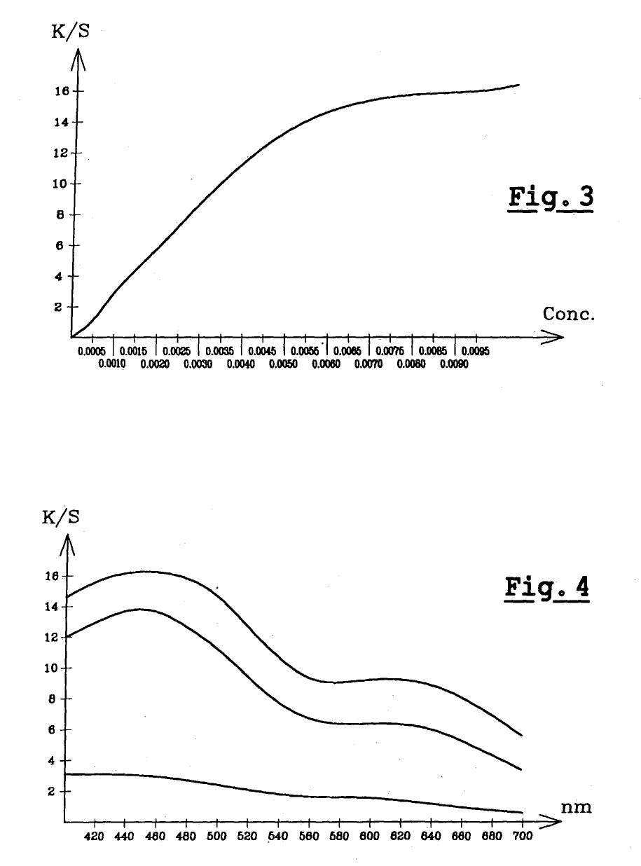

FIGS. 3 and 4 show examples of calibration curves for a binary mixture of an oxidation base, para-phenylenediamine, and of an oxidation coupler, resorcinol.

FIG. 3 shows a curve representing the coefficient K/S as a function of the concentration of the dye component, and for a given wavelength. The curve representing the coefficient K/S as a function of the concentration of the dye component is not rectilinear, which shows that the coefficient K/S is not linearly proportional to the concentration. Thus, it is not possible to determine the coloration obtained with a dye component at a given concentration solely by multiplying the value of the coefficient K/S with a coefficient of proportionality. This is also the case for FIG. 4, in which the curve representative of K/S as a function of the wavelength is also not rectilinear. Thus, for each composition of dye product, it is necessary to record several values of the coefficient K/S for different concentrations and for different wavelengths.

Accordingly, as shown in FIG. 2, the database 10 includes a set 12 of data 14, which are values representative of the real color obtained with each dye product. The database 10 also includes a first set of data 16 for identifying a set of dye components suitable for being included in the compositions of the dye products that it is desired to determine. Each of these data 16 allows a single dye component to be identified, and it can include either a chemical name of the dye component, or a code, or alternatively can include a chemical structure of the dye component.

According to one embodiment of the invention, the database 10 includes another set 18 of data 20 relating to the conditions for applying each dye product. The database 10 can also include a set 22 of data 24 that are representative of economic or regulatory characteristics relating to the dye products. These characteristics can be, for example, the price of each dye product, toxicological data, or data relating to the industrial property rights.

Thus, as may be seen in FIG. 2, the database 10 includes a first set of data 16 that are the data for identifying the dye components, a second set 12 of data 14 for defining the coloration obtained with each dye product, a third set 22 of data 24 representative of economic or regulatory characteristics of the dye product, and a fourth set 18 of data 20 for defining the conditions for applying the dye products.

For each dye product, the database 10 provides a value for each of the data 16, this value being the proportion of the dye component identified by the first set of data 16 for the dye product. By way of example, if the dye product does not include a dye component, the value associated with this dye component is zero. According to one embodiment of the invention, no value is displayed if the dye product does not include the dye component. Also, for each dye product, the database 10 provides a value for each of the data 14, this value being the value of the coefficient K/S for a wavelength value. The database 10 also provides a value with each of the data 20 and 24, these values possibly being numerical or alphanumerical.

The invention also covers a process for producing such a database 10. This process includes a first step of recording a first set of data, i.e. the name (or other identification) of each dye component that can be included in the composition of a dye product, and a second step of recording a plurality of dye products. The second step of recording the plurality of dye products includes recording, for each dye product, the proportion of each dye component included in the composition of the dye product, and further includes associating this proportion with the data 16 identifying the dye component.

The process for compiling the database 10 includes performing tests for each dye product on samples of fibers, as a function of the various sets of data relating to the dye products. The coloration obtained by each dye product on a given sample of fibers can be measured, for example, using an electronic spectrocolorimeter. Next, the values of the coefficient K/S for different wavelength values are determined and are then recorded in the database 10.

The database 10 can take a relatively long time to produce because numerous tests need to be performed. For this reason, the process for compiling the database 10 is performed in several steps, and it includes a first step of recording dye products with a known final coloration, and it includes at least one step of updating the database 10, which includes recording the dye products whose final coloration has been determined from the first recording step or from the preceding updating step.

Once the database 10 has been compiled, it can be made available to the user, such as the professional who will produce the dye products. The user can be a hair stylist working in a hair salon or a dye product manufacturer.

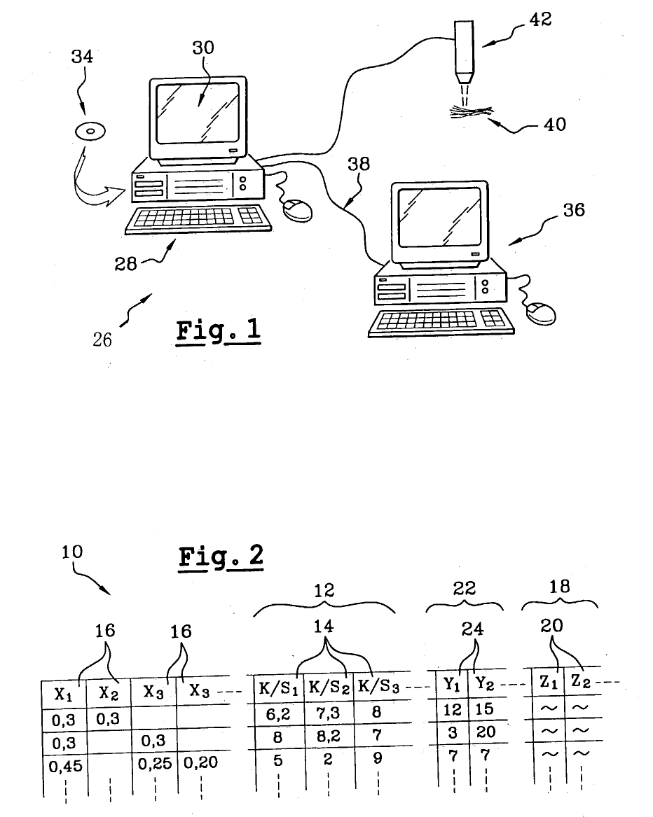

The user has at his disposal an electronic device 26 as shown in FIG. 1, which includes means 28 for entering the target coloration, display means 30 and means for interrogating the database 10. The electronic device 26 may be, for example, a computer, in which the database 10 is recorded, in an internal component, for instance a hard drive, or on a removable component, for instance on a CD ROM 34.

The computer can thus be connected to a second computer 36 via any known means, for instance an network 38 which may be in-house, in which case it is referred to as an “Intranet,” or via an external network, for instance the Internet. An updating step takes place by sending the user a program that is recorded on any conventional medium, for instance a CD-ROM. The user then runs the program in order to update the database.

According to another embodiment of the invention, when the computer 26 which is available to the user is connected to a second central computer 36, the database 10 is recorded only in this second computer. Thus, during the selection step, the computer interrogates the database 10 that is recorded in the second computer. This can simplify the successive database updating operations, since there is only one database 10 to be modified rather than the number of databases formed by the users. Furthermore, once the database 10 of the central computer has been updated, all the users who apply the process have at their disposal the new dye compositions, without having to perform an updating task, which may be complicated.

The components of the computers 26 and/or 36 (e.g., the CPU and RAM) can perform various functions described above. For example, the computers 26 and/or 36 can receive data representing a target coloration, and can search the database based on the target coloration. The computers 26 and/or 36 can select from the database a dye product based on the target coloration and identify dye components and proportions of the dye components for the dye product. The computers 26 and/or 36 can transmit data representing the dye components and the proportions, for example to the network 38 and/or to a display device. Instructions for performing these functions can be stored as a computer program product accessed by the components of the computers 26 and/or 36.

The invention also covers a process for determining the composition of a dye product for obtaining a target coloration desired by an individual, or alternatively a coloration close to the target coloration. To achieve this determination, a first step of the process in accordance with the invention includes entering the target coloration in electronic form. This entering step can be performed using a color chart that is present in electronic data form. In this case, the computer 26 performing the determination process includes software for aiding in the selection of the colorations. According to one embodiment of the invention, the entering step is performed using a color chart that is in the form of a “material” catalogue made, for example, of paper, and which includes a single code associated with each of the colorations it collates. When the desired coloration is not present in the color chart, but is present on another support, for instance a lock 40 of hair of a third party or a catalogue of colored locks, the step of entering the target coloration includes electronically determining the spectral curve of the target coloration. To perform this step, the entering means 28 of the electronic device include, for example, of an electronic calorimeter 42, which is connected to the user's computer 26.

Non-limiting examples of calorimeters or spectrocolorimeters which can be incorporated in the present invention include Spectraflash SF600, Spectraflash SF300, Microflash 200d, or Mercury 1000 and 2000 sold by the company Datacolor, and CM 1000, 2000 or 3000 sold by the company Minolta.

When some of the third items of data 24 of the database 10 relate to the initial coloration of the hair to be dyed, the entering step also includes a step of analyzing the hair to be dyed, which is performed in the same manner as the step of entering the target coloration, i.e. either directly on the computer 26, using a color chart, or via the spectrocolorimeter 42 at the user's disposal. This step permits either to select the correct database or the correct subset of the database, or to introduce a correction factor for the subsequent calculations.

Next, according to a second step of the process, the computer 26 determines by calculation one or more compositions of dye products for obtaining the target coloration or a theoretical coloration close to the target coloration. To perform this step, the computer 26 interrogates the database 10 and calculates the difference ΔE* between the theoretical coloration obtained by each of the dye products recorded in the database 10, and the target coloration.

The computer 26 also determines compositions of dye products that are not recorded in the database 10, and calculates the difference ΔE* between the theoretical coloration obtained for each of the determined compositions and the target coloration. Finally, the computer 26 selects the dye products that allow the target coloration to be obtained.

When no dye product provides a theoretical coloration identical to the target coloration to be obtained, the computer 26 selects the dye products to obtain a theoretical coloration close to the target coloration. A coloration is considered as close to the target coloration when the difference ΔE* is less than or equal to a predetermined value. By way of non-limiting example, the predetermined value that can be taken for the difference ΔE* is the minimum value for which the difference between two colorations is perceptible by the human eye, which is equal to 2.

According to one embodiment of the invention, the computer 26 selects a predetermined number of dye products for obtaining theoretical colorations which are closest to the target coloration. This determination step is performed via a formulation software, for example the Datamatch or DCI Match software sold by the company Datacolor, Isomatch sold by the company SPC, Prisma or Spectramatch sold by the company Minolta, QuicInkPlus sold by the company X-Rite, and “Ink Formulation and Mixing” and “Propalette Textile” sold by the company Gretagmacbeth.

After the determination step, the process includes a step of displaying the results of the determination step, which includes displaying, for example on the screen 30 of the computer 26 or by printing out on paper, the composition of each of the determined dye products. The display step can include displaying the first items of data 16 identifying the dye components that form part of the composition of the dye product, and also the proportion of each of the dye components in the form of a list.

To facilitate the choice of the dye product which will be produced, according to one preferred embodiment of the invention, the display step includes displaying the compositions of the products determined during the determination step by arranging them in order of proximity between the theoretical coloration obtained by each of the dye products and the target coloration, preferably from the closest to the furthest theoretical coloration. In this display step, according to a preferred embodiment of the invention, a representative value of the difference between the target coloration and the theoretical coloration obtained by each dye product is also displayed, which allow the individuals who select the dye product which will be produced to evaluate the coloration “difference.”

This representative value should be significant for the person who makes the final choice of the dye product to be produced. It can thus include a numerical value of the variation ΔE* of the dye product under consideration. According to one embodiment of the invention, this representative value includes a graph component, for example a “lozenge” colored in the theoretical color obtained by the dye product. Alternatively it includes a graphical representation colored in two colors, a first color being the theoretical coloration obtained by the dye product under consideration, and the second color being the target coloration.

When the database 10 also includes the third items of data 24 representative of economic or regulatory characteristics, the display step also includes displaying these third items of data 24 for each of the dye products determined during the determination step.

When the user of such a process is a hair stylist, the user may not have available all the dye components recorded in the database 10. Consequently, according to one variant of the invention, the determination process includes a second step of entering a set of dye components that the user possesses. This second entering step can also be used by the dye product manufacturer who wishes to design a dye product as a function of economic characteristics, for example as a function of the cost price of the dye components.

The user can select the dye product to be produced as a function of the displayed compositions of dye products. The choice can be made as a function of the coloration theoretically obtained. Various other parameters, such as for example the dye components at the user's disposal or the complexity of producing the dye product, can also be taken into consideration.

Once the composition of the dye product has been selected, the user is then able to produce the selected dye product. To perform this step, the invention covers a process for producing a dye product whose composition has been determined from the determination process described above. This producing process includes a step of mixing together all the dye components mentioned during the display step, and a step of mixing them in the proportions mentioned during the display step.

The user can perform the metering himself by manually metering out the dye components required to prepare the dye product. Alternatively, an automatic device (not shown), connected to the computer 26, can meter out each component and mix the components together to make the dye product.

Once the dye product has been produced, the hair stylist is able to apply it to the hair to be dyed in order to obtain the desired coloration. According to one particular embodiment, the dye components are mixed, preferably at the time of use, with a composition containing, in a medium that is suitable for dyeing, at least one oxidizing agent, this oxidizing agent being present in an amount sufficient to develop a coloration. The mixture obtained is then applied to the keratin fibers. After an action time of, for example, about 3 to 50 minutes, and preferably about 5 to 30 minutes, the keratin fibers can be rinsed, washed with shampoo, rinsed again and then dried.

The oxidizing agents conventionally used for the oxidation dyeing of keratin fibers are, for example, hydrogen peroxide, urea peroxide, alkali metal bromates, persalts such as perborates and persulphates, peracids and oxidase enzymes, which can include peroxidases, 2-electron oxidoreductases such as uricases, and 4-electron oxygenases, for instance laccases. Hydrogen peroxide is particularly preferred.

The oxidizing composition can also include various adjuvants conventionally used in compositions for dyeing the hair and as defined above. The pH of the oxidizing composition containing the oxidizing agent can be such that, after mixing with the dye components, the pH of the resulting dye product applied to the keratin fibers ranges preferably between 3 and 12 approximately and even more preferably between 5 and 11. It can be adjusted to the desired value by means of acidifying or basifying agents usually used in the dyeing of keratin fibers and as defined above. The ready-to-use composition which is finally applied to the keratin fibers can be in various forms, such as in the form of liquids, creams or gels or in any other form suitable for dyeing keratin fibers, and especially human hair.

According to another embodiment of the invention, the display step includes displaying the conditions for applying the dye product, for instance the action time or the application temperature. The user can then directly know the conditions for applying the selected dye product.

The mechanisms and processes set forth in the present description may be implemented using a conventional general purpose microprocessor(s) programmed according to the teachings of the present specification, as will be appreciated to those skilled in the relevant arts. Appropriate software coding can readily be prepared by skilled programmers based on the teachings of the present disclosure, as will also be apparent to those skilled in the relevant arts. In particular, the computer program product for determining a composition of a dye product for dyeing keratin fibers according to the present invention can be written in a number of computer languages including but not limited to C, C⁺⁺, Fortran, and Basic, as would be recognized by those of ordinary skill in the art. The invention may also be implemented by the preparation of applications specific integrated circuits or by interconnecting an appropriate network of conventional component circuits, as will be readily apparent to those skilled in the art.

The present invention thus also includes a computer-based product that may be hosted on a storage medium and include instructions that can be used to program a computer to perform a process in accordance with the present invention. This storage medium can include, but is not limited to, any type of disk including floppy disks, optical disks, CD-ROM, magneto-optical disks, ROMs, RAMs, EPROMs, EEPROMs, Flash Memory, Magnetic or Optical Cards, or any type of media suitable for storing electronic instructions.

Obviously, numerous modifications and variations of the present invention are possible in light of the above teachings. It is therefore to be understood that, within the scope of the appended claims, the invention may be practiced otherwise than as specifically described herein.

What is claimed as new and desired to be secured by Letters Patent of the United States is:

1. A process for determining a composition of a dye product for dyeing keratin fibers, comprising the steps of:
entering at least one item of data representative of a target coloration;
determining, from a database, a dye product based on said target coloration; and
displaying the composition of said dye product, identifying at least one dye component to produce said dye product, and further identifying a proportion for said at least one dye component.

2. The process of claim 1, wherein said displaying identifies a plurality of dye components to produce said dye product and further identifies relative proportions for said dye components.

3. The process of claim 1, wherein said determining step comprises determining a dye product for obtaining the target coloration.

4. The process of claim 1, wherein said determining step comprises determining a dye product for obtaining a theoretical coloration that differs from the target coloration by not more than a predetermined theoretical value.

5. The process of claim 1, wherein said determining step comprises determining a predetermined number of dye products for obtaining theoretical colorations that are close to the target coloration, and wherein said displaying step includes displaying at least one of said dye products.

6. The process of claim 4, wherein said displaying step comprises displaying a value representative of a difference between the theoretical coloration obtained with the dye product and the target coloration.

7. The process of claim 4, wherein said displaying step comprises displaying a colored graph component whose coloration is the theoretical coloration obtained with the dye product.

8. The process of claim 4, wherein said determining step comprises determining a plurality of dye products based on said target coloration.

9. The process of claim 8, wherein said displaying step comprises displaying the dye products arranged in order of proximity between the theoretical coloration and the target coloration.

10. The process of claim 1, wherein the determining step comprises selecting a dye product identified in the database.

11. The process of claim 1, wherein the determining step comprises determining the composition of said dye product by numerical calculation.

12. The process of claim 1, wherein said at least one dye component comprises an oxidation base.

13. The process of claim 12, wherein said at least one dye component further comprises an oxidation coupler.

14. The process of claim 1, wherein said at least one dye component comprises a direct dye.

15. The process of claim 1, wherein said keratin fibers are human hairs.

16. The process of claim 1, further comprising a step of entering at least one characteristic of said keratin fibers.

17. The process of claim 16, wherein said step of entering said at least one characteristic comprises entering at least one item of data representative of a real color of the keratin fibers.

18. The process of claim 17, further comprising a step of identifying a subset of dye components chosen from all dye components in the database, and wherein said determining step comprises determining dye products formed from one or more dye components of the said subset.

19. A process for preparing a dye product, comprising the steps of:
determining a proportion for at least one dye component of the dye product using the process of claim 1; and
preparing said dye product by incorporating said at least one dye component determined by said determining step, in the proportion determined by said determining step.

20. A database for determining a composition of a dye product for dyeing keratin fibers, comprising:
a first set of data identifying a plurality of dye components for making a plurality of dye products; and
a second set of data identifying concentrations of the dye components, and colors obtained when said dye products made with said dye components are applied to said keratin fibers.

21. The database of claim 20, further comprising a third set of data representative of economic characteristics relating to at least one of said dye products.

22. The database of claim 20, further comprising a third set of data representative of regulatory characteristics relating to at least one of the said dye products.

23. A process for compiling the database of claim 20, comprising the steps of:
recording said first set of data; and
recording said second set of data.

24. The process of claim 23, further comprising a step of updating the database by recording the second set of data relating to at least one new dye product.

25. A system for determining a composition of a dye product for dyeing keratin fibers, comprising:
means for entering at least one set of data representative of a target coloration;
calculation means for determining, from a database, the dye product based on said target coloration; and
means for displaying the composition for said dye product, identifying at least one dye component to produce said dye product, and further identifying a proportion of said at least one dye component.

26. The system of claim 25, wherein said calculation means comprises means for determining at least one dye product for obtaining the target coloration.

27 The system of claim 25, wherein said calculation means comprises means for determining at least one dye product for obtaining a theoretical coloration that differs from the target coloration by not more than a predetermined theoretical value.

28. The system of claim 25, wherein said calculation means comprises means for determining a predetermined number of dye products for obtaining theoretical colorations that are close to the target coloration, and wherein said displaying means comprises a means for displaying at least one of said dye products.

29. The system of claim 25, wherein the database is remotely located relative to the display means, data between said database and said display means being transmitted over a network.

30. The system of claim 29, wherein said calculation means is remotely located relative to the display means.

31. The system of claim 29, wherein said database is remotely located relative to the entering means.

32. The system of claim 29, wherein said network is the Internet.

33. The system of claim 25, wherein the means for entering comprises a colorimeter.

34. The system of claim 25, wherein the means for entering comprises a electronic spectrocolorimeter.

35. A computer program product, comprising:
a computer storage medium and a computer program code mechanism embedded in the computer storage medium for causing a computer to determine a composition of a dye product for dyeing keratin fibers, the computer program code mechanism comprising:
a first computer code device configured to receive data representative of a target coloration;
a second computer code device configured to perform a search of a database based on said target coloration;
a third computer code device configured to identify at least one dye component of said dye product and a proportion for said at least one dye component; and
a fourth computer code device configured to transmit said at least one dye component and said proportion.

36. The computer program product of claim 35, wherein:
said third computer code device is configured to identify a plurality of dye components of said dye product and relative proportions for said dye components; and
said fourth computer code device is configured to transmit said plurality of dye components and said relative proportions.

37. The computer program product of claim 35, wherein:
said third computer code device is configured to select from said database said dye product which provides said target coloration.

38. The computer program product of claim 35, wherein:
said third computer code device is configured to select from said database said dye product which provides a product coloration that differs from the target coloration by not more than a predetermined value.

39. The computer program product of claim 38, wherein:
said fourth computer code device is configured to transmit a value representative of a difference between said product coloration and said target coloration.

40. The computer program product of claim 35, wherein said computer storage medium comprises said database.

41. The computer program product of claim 40, wherein said database stores identification data for a plurality of dye components.

42. The computer program product of claim 41, wherein said database stores proportions for each dye component of said plurality of dye components and for a plurality of dye products.

43. The computer program product of claim 42, wherein said database stores color data for each of said dye products.

44. A process for determining a composition of a dye product for dyeing keratin fibers, comprising the steps of:
receiving data representing a target coloration;
searching a database based on said target coloration;
selecting from said database at least one dye product based on said target coloration;
identifying dye components and proportions of said dye components for said at least one dye product; and
transmitting data representing said dye components and said proportions.

45. The process of claim 44, wherein said at least one dye product provides the target coloration.

46. The process of claim 44, wherein said at least one dye product provides a product coloration that differs from the target coloration by not more than a predetermined value.

47. The process of claim 46, wherein said predetermined value corresponds to a minimum value for which the difference between the product coloration and the target coloration is perceptible by a human eye.

48. The process of claim 44, wherein said transmitting is performed over a network toward a remote user.

49. The process of claim 44, wherein said transmitting is performed toward a display device.

50. The process of claim 49, further comprising displaying with said display device said data representing said dye components and said proportions.
